(19) United States
(12) Patent Application Publication
(10) Pub. No.: US 2022/0221818 A1
(43) Pub. Date: Jul. 14, 2022

(54) CONNECTION STRUCTURE BETWEEN A DOOR FOR REPLACING A WASTE TONER CONTAINER AND A PRINT MEDIUM CASSETTE

(71) Applicant: Hewlett-Packard Development Company, L.P., Spring, TX (US)

(72) Inventors: Younghoon KIM, Seongnam-si (KR); Hanjun LEE, Seongnam-si (KR); Chanhyun PARK, Seongnam-si (KR)

(21) Appl. No.: 17/609,276

(22) PCT Filed: May 22, 2020
(86) PCT No.: PCT/US2020/034198

§ 371 Date: Nov. 5, 2021

(30) Foreign Application Priority Data
Oct. 2, 2019 (KR) 10-2019-0122668

(51) Int. Cl. G03G 21/12

(52) U.S. Cl. CPC G03G 21/12

(57) ABSTRACT

An example image forming apparatus includes a main body including a printing unit, a waste toner container, and a door, an opening lever movable between a first position, in which the door is locked in a closed position, and a second position allowing opening of the door, a print medium cassette located under the main body and moveable between a mounted position and a withdrawn position, and a locking member movable between a locking position, in which the opening lever is locked in the first position, and a releasing position, in which the locking of the opening lever is released when the print medium cassette is in the mounted position.

### BACKGROUND

An image forming apparatus using an electrophotographic method forms a visible toner image on a photoconductor by supplying toner to an electrostatic latent image formed on the photoconductor, transfers the toner image to a print medium, fixes the transferred toner image to the print medium, and prints an image on the print medium. A developing device contains toner and supplies the toner to the electrostatic latent image formed on the photoconductor to form the visible toner image on the photoconductor.

Waste toner produced during an image forming process is contained in a waste toner container. The waste toner container may be removed from the image forming apparatus, such as when the waste toner container is filled with waste toner, and a new waste toner container may be mounted therein.

### BRIEF DESCRIPTION OF DRAWINGS

Various examples will be described below by referring to the following figures.

FIG. 1 is a view schematically illustrating an electrophotographic image forming apparatus according to an example.

FIG. 2 is a perspective view illustrating an external appearance of the electrophotographic image forming apparatus shown in FIG. 1 according to an example.

FIG. 3 is a schematic perspective view illustrating a replacement structure for a waste toner container according to an example.

FIG. 4 is a schematic bottom perspective view illustrating the replacement structure for the waste toner container shown in FIG. 3 according to an example.

FIG. 5 is a schematic bottom perspective view illustrating a print medium cassette in a withdrawn position in the replacement structure for the waste toner container shown in FIGS. 3 and 4 according to an example.

FIG. 6 is a schematic bottom perspective view illustrating a print medium cassette in a mounted position in the replacement structure for the waste toner container shown in FIGS. 3 and 4 according to an example.

FIG. 7 is a view schematically illustrating an electrophotographic image forming apparatus according to an example.

FIG. 8 is a perspective view illustrating an external appearance of the electrophotographic image forming apparatus shown in FIG. 7 according to an example.

FIG. 9 is a schematic perspective view illustrating a replacement structure for a waste toner container applied to the image forming apparatus shown in FIG. 7 according to an example.

### DETAILED DESCRIPTION OF EXAMPLES

Hereinafter, various examples will be described with reference to the drawings. Like reference numerals in the specification and the drawings denote like elements, and thus a redundant description may be omitted.

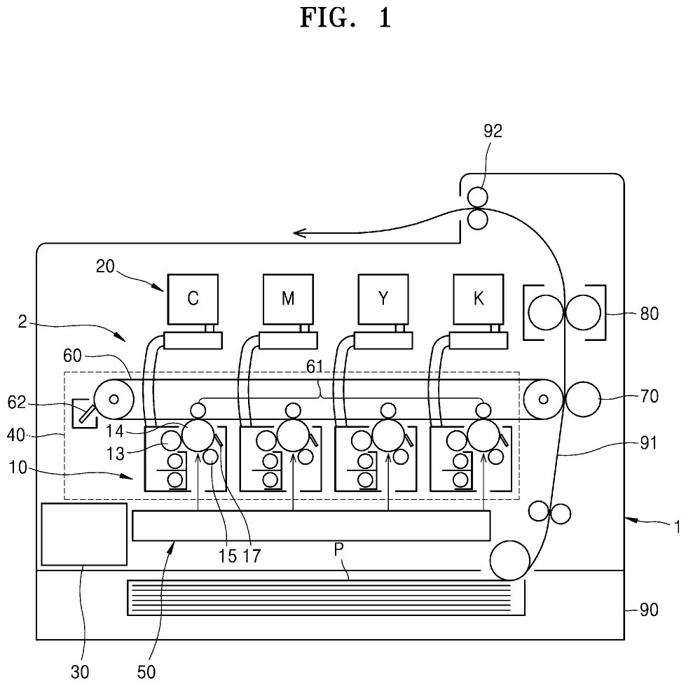

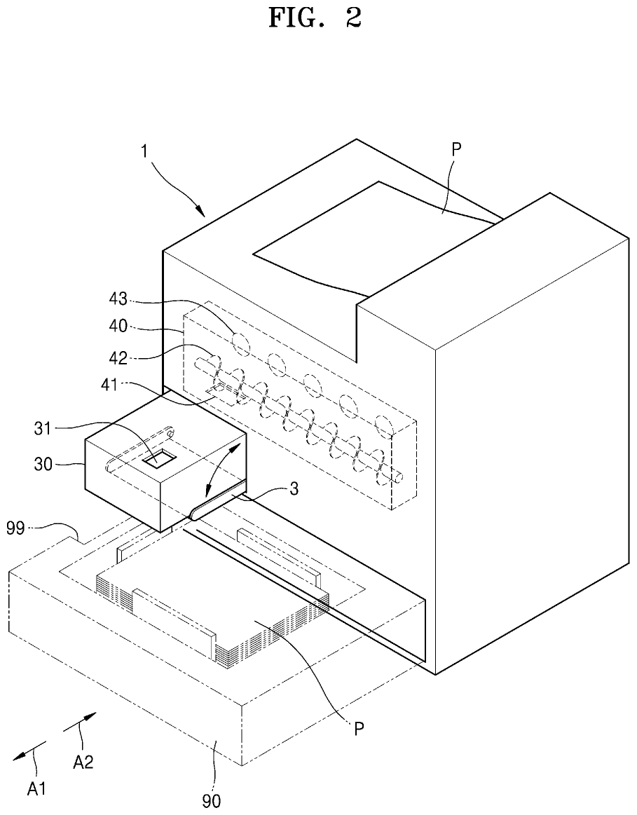

FIG. 1 is a view schematically illustrating an electrophotographic image forming apparatus according to an example. FIG. 2 is a perspective view illustrating an external appearance of the electrophotographic image forming apparatus shown in FIG. 1 according to an example.

Referring to FIGS. 1 and 2, the electrophotographic image forming apparatus includes a main body 1 and a print medium cassette 90 that may be loaded with a print medium P to be fed into the main body 1. The main body 1 may include a printing unit 2, a waste toner container 30 to contain waste toner discharged from the printing unit 2, and a door 3 that may be opened or closed to replace the waste toner container 30. The print medium cassette 90 may be provided under the main body 1 to move between a mounted position (FIG. 1) in which the print medium cassette 90 is pushed into the main body 1 and a withdrawn position (FIG. 2) in which the print medium cassette 90 is pulled out from the main body 1. The print medium P may be loaded in the print medium cassette 90 in the withdrawn position.

The printing unit 2 may print a color image on the print medium P by using an electrophotographic method. The printing unit 2 may include a plurality of developing devices 10, an exposure unit 50, a transfer unit, and a fusing unit 80. The printing unit 2 may further include a plurality of toner cartridges 20, respectively connected to the plurality of developing devices 10, to contain a developer and to supply the developer to the plurality of developing devices 10, respectively. The plurality of toner cartridges 20 and the plurality of developing devices 10 may be detachably connected to the main body 1 and may be replaced independently.

In an example, the plurality of developing devices 10 may include a plurality of developing devices 10C, 10M, 10Y, and 10K for forming toner images of cyan (C), magenta (M), yellow (Y), and black (K) colors. The plurality of toner cartridges 20 may include a plurality of toner cartridges 20C, 20M, 20Y, and 20K respectively containing toners of cyan (C), magenta (M), yellow (Y), and black (K) colors to be supplied to the plurality of developing devices 10C, 10M, 10Y, and 10K, respectively. Hereinafter, reference numerals with letters C, M, Y, and K respectively denote elements for forming C, M, Y, and K images unless otherwise stated.

Each of the developing devices 10 may include a photosensitive drum 14 on which an electrostatic latent image may be formed, and a developing roller 13 to develop the electrostatic latent image into a visible toner image by supplying toner to the electrostatic latent image. The photosensitive drum 14 is an example of a photoconductor on which an electrostatic latent image may be formed and may include a conductive metal pipe and a photosensitive layer formed on an outer circumferential surface thereof. A charging roller 15 is a charger for charging the surface of the photosensitive drum 14 to a uniform electric potential. A charging brush or a corona charger may also be used instead of the charging roller 15.

The exposure unit 50 emits light, which is modulated to correspond to image information, to the photosensitive drum 14 and forms an electrostatic latent image on the photosensitive drum 14. A laser scanning unit using a laser diode as a light source or a light-emitting diode (LED) exposure unit using an LED as a light source may be used as the exposure unit 50.

The developing roller 13 is spaced apart from the photosensitive drum 14. An interval between an outer circumferential surface of the developing roller 13 and an outer circumferential surface of the photosensitive drum 14 may be, for example, tens of to hundreds of microns. The developing roller 13 may have a form in which a magnetic member is located in a rotating developing sleeve. In the developing device 10, toner may be mixed with a magnetic carrier, and the toner is attached to the surface of the magnetic carrier. The magnetic carrier is attached to the surface of the developing roller 13 to be transported to a developing region where the photosensitive drum 14 faces the developing roller 13. A regulating member (not shown) regulates an amount of toner and carrier transported to the developing region. Only toner is to be supplied to the photosensitive drum 14 by a development bias voltage applied between the developing roller 13 and the photosensitive drum 14 to develop an electrostatic latent image formed on the photosensitive drum 14 into a visible toner image.

The transfer unit transfers the toner image formed on the photosensitive drum 14 to the print medium P. For example, the transfer unit may include an intermediate transfer belt 60, an intermediate transfer roller 61, and a transfer roller 70. The intermediate transfer belt 60 temporarily receives toner images developed on the photosensitive drums 14 of the plurality of developing devices 10C, 10M, 10Y, and 10K. A plurality of intermediate transfer rollers 61 are located to face the photosensitive drums 14 of the plurality of developing devices 10C, 10M, 10Y, and 10K with the intermediate transfer belt 60 therebetween. An intermediate transfer bias voltage for intermediate-transferring the toner images developed on the photosensitive drum 14 to the intermediate transfer belt 60 is applied to the plurality of intermediate transfer rollers 61. The transfer roller 70 is located to face the intermediate transfer belt 60. The print medium P output from the print medium cassette 90 is transported along a feed path 91 between the transfer roller 70 and the intermediate transfer belt 60. A transfer bias voltage for transferring the toner images intermediately transferred to the intermediate transfer belt 60 to the print medium P is applied to the transfer roller 70.

The fusing unit 80 fixes the toner images transferred to the print medium P onto the print medium P by applying heat and/or pressure to the toner images. A shape of the fusing unit 80 is not limited to that shown in FIG. 1. The print medium P having the image is discharged to the outside of the main body 1 by a discharge roller 92.

Toner or foreign material remaining on the surface of the photosensitive drum 14 may be removed by a cleaning member 17 after the intermediate transfer process. After the transfer process, toner or foreign material remaining on the surface of the intermediate transfer belt 60 may be removed by a cleaning member 62. When an auto developer refill (ADR) method is used, the toner cartridge 20 may also include a small amount of a carrier as well as the toner, and the toner and the carrier are supplied to the developing device 10. In order to maintain a desired amount of the developer (toner and carrier) contained in the developing device 10, an excess of the developer may be discharged from the developing device 10. The toner and the foreign material removed from the photosensitive drum 14 and the intermediate transfer belt 60 and the excess developer discharged from the developing device 10 are referred to as ‘waste toner’. The waste toner may be transported to the waste toner container 30 by a transfer unit (not shown) and contained in the waste toner container 30.

As indicated by dashed lines in FIGS. 1 and 2, an intermediate container 40 may be interposed between the printing unit 2 and the waste toner container 30. The intermediate container 40 may temporarily contain waste toner discharged from the printing unit 2. The intermediate container 40 may have five inlets 43 through which waste toner respectively removed from the four photosensitive drums 14 and waster toner removed from the intermediate transfer belt 60 is introduced. The intermediate container 40 may have a waste toner outlet 41. The waste toner container 30 may have a waste toner inlet 31. The waste toner outlet 41 is connected to the waste toner inlet 31. Although not shown in the drawings, each of the waste toner outlet 41 and the waste toner inlet 31 may be provided with a shutter for opening or closing thereof. The shutter may open the waste toner outlet 41 and the waste toner inlet 31 based on an operation of mounting the waste toner container 30 in the main body 1 and may close the waste toner outlet 41 and the waste toner inlet 31 when the waste toner container 30 is removed from main body 1. The intermediate container 40 may be provided with a transport member 42 to transport the waste toner into the waste toner container 30. The transport member 42 may include an auger that transports the waste toner to the waste toner outlet 41. In this structure, the waste toner that has been discharged from the printing unit 2 and contained in the intermediate container 40 may be transported to the waste toner outlet 41 by the transport member 42 and stored in the waste toner container 30 through the waste toner inlet 31. A connection pipe (not shown) may be disposed between the intermediate container 40 and the waste toner container 30. Each of the waste toner outlet 41 and the waste toner inlet 31 may be connected to the connection pipe.

The waste toner container 30 may be replaceable. For example, when the waste toner container 30 is filled with waste toner, the waste toner container 30 may be removed from the main body 1, and a new waste toner container 30 may be mounted in the main body 1.

As shown in FIGS. 1 and 2, the waste toner container 30 is provided in the main body 1. The waste toner container 30 is exposed to the outside by opening a portion of the main body 1 by opening (e.g., rotating) the door 3. In the state in which the door 3 is opened, the waste toner container 30 may be removed from the main body 1 by sliding the waste toner container 30, and a new waste toner container 30 may be mounted in the main body 1.

The print medium cassette 90 is provided under the main body 1 and may be pulled out. The print medium cassette 90 is located under the waste toner container 30. The print medium cassette 90 may move to the withdrawn position as shown in FIG. 2 to load the print medium P therein. After loading the print medium P, the print medium cassette 90 may slide in a direction opposite to the direction when the print medium cassette 90 is pulled out to move to the mounted position.

A portion of the waste toner container 30, such as a portion of the waste toner container 30 adjacent to the waste toner inlet 31, may be contaminated by waste toner. During a process of removing the waste toner container 30, waste toner may fall from the waste toner container 30. When the waste toner container 30 is removed from the main body 1 in a state in which the print medium cassette 90 is in the withdrawn position, the inside of the print medium cassette 90 and the print medium P loaded in the print medium cassette 90 may be contaminated by waste toner falling from the waste toner container 30. When the print medium cassette 90 is moved to the mounted position in this state, the inside of the main body 1 may be contaminated by waste toner. In addition, when the contaminated print medium P is transported along the feed path 91, the feed path 91 may be contaminated by waste toner.

An image forming apparatus according to the example has a replacement structure for the waste toner container 30 which inhibits the door 3 from being opened in a state in which the print medium cassette 90 is in the withdrawn position and allows the door 3 to be opened in conjunction with the movement of the print medium cassette 90 from the withdrawn position to the mounted position. Hereinafter, examples of a replacement structure for the waste toner container 30 will be described.

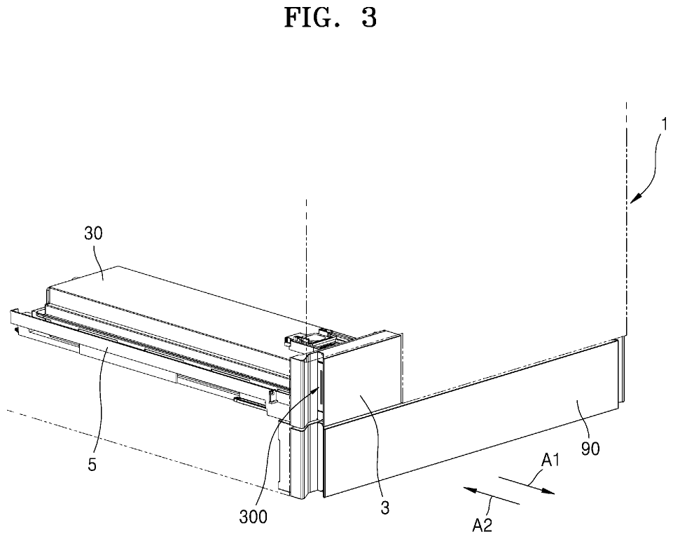

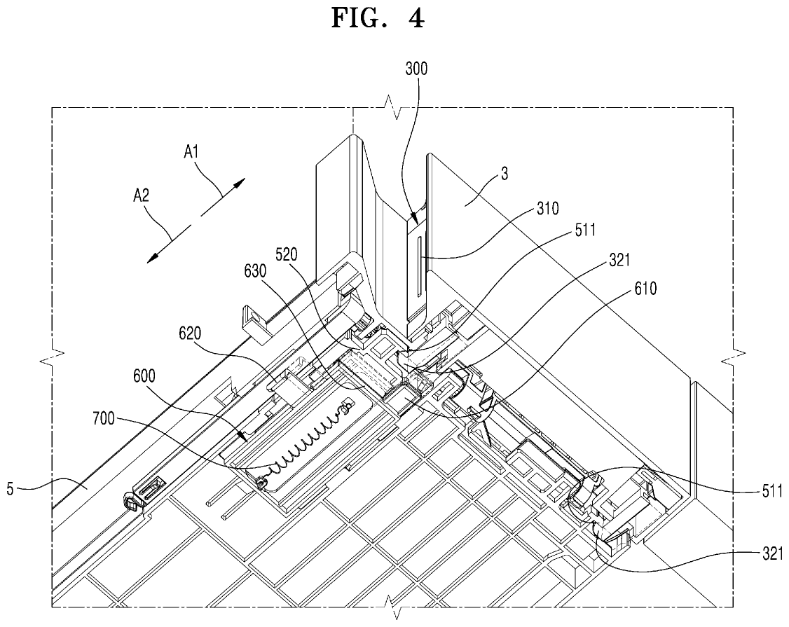

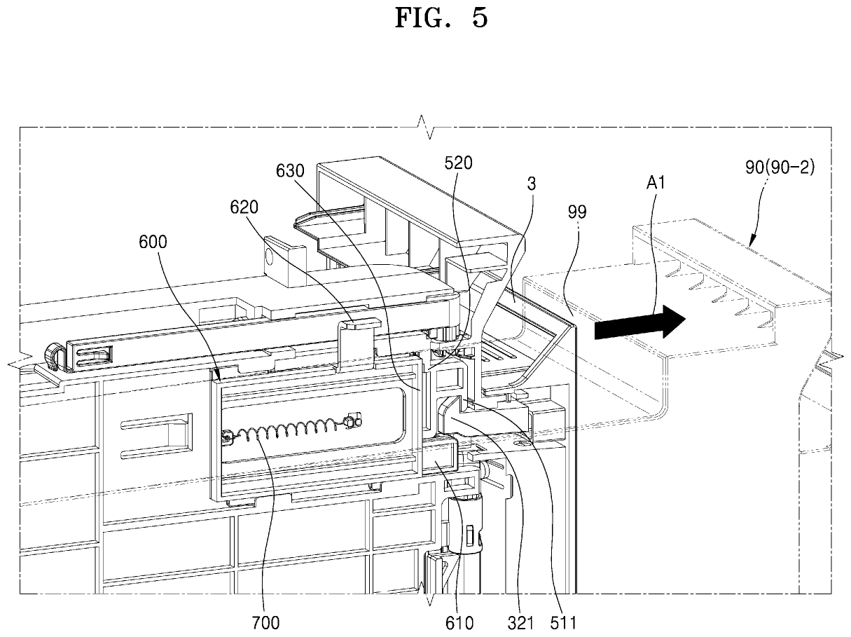

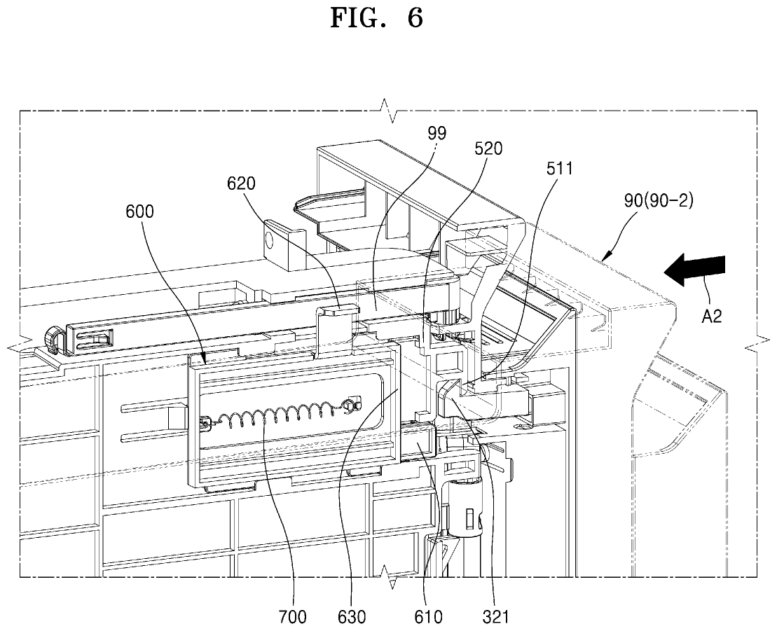

FIG. 3 is a schematic perspective view illustrating a replacement structure for a waste toner container according to an example. FIG. 4 is a schematic bottom perspective view illustrating the replacement structure for the waste toner container shown in FIG. 3 according to an example. FIG. 5 is a schematic bottom perspective view illustrating a print medium cassette in a withdrawn position in the replacement structure for the waste toner container shown in FIGS. 3 and 4 according to an example. FIG. 6 is a schematic bottom perspective view illustrating a print medium cassette in a mounted position in the replacement structure for the waste toner container shown in FIGS. 3 and 4 according to an example. In FIG. 4, the print medium cassette 90 is omitted for sake of clarity. In FIGS. 5 and 6, the print medium cassette 90 is marked as two-dot chain lines.

Referring to FIGS. 3 to 6, an opening lever 300 and a locking member 600 are shown. The opening lever 300 may move between a first position (marked as a solid line in FIG. 4), in which the door 3 is locked in a closed position, and a second position (marked as dashed lines in FIG. 4) in which the opening of the door 3 is allowed. The locking member 600 may move between a locking position (marked as dashed lines in FIG. 4) in which the opening lever 300 is locked in the first position and a releasing position (marked as a solid line in FIG. 4) in which the locking of the opening lever 300 is released in conjunction with the movement of the print medium cassette 90 from the withdrawn position to the mounted position thereof. An elastic member 700 applies an elastic force to the locking member 600 in a direction toward the locking position.

Referring to FIG. 4, the opening lever 300 may be provided at the door 3 to slide between the first position and the second position. The opening lever 300 may include a pressing portion 310 exposed to the outside of the door 3 to operate the opening lever 300 from the outside and a first holding portion 321 to be caught by a second holding portion 511 provided at the main body 1 in the first position to prevent the door 3 from being opened. In an example, the opening lever 300 slides in a direction perpendicular to a pulling direction A1 of the print medium cassette 90 to move between the first position and the second position. The opening lever 300 may be elastically biased by a spring (not shown) to slide to the first position. A user may move the opening lever 300 from the first position to the second position by sliding the opening lever 300 in a direction opposite to an elastic force of the spring by pressing the pressing portion 310. When the pressure applied to the pressing portion 310 is removed, the opening lever 300 may return to the first position from the second position by the elastic force of the spring. The spring may be implemented in various forms such as a coil spring, a leaf spring, etc. and may also be implemented in the form of an elastic arm integrated with the opening lever 300.

The main body 1 may be provided with a support frame 5 that supports the waste toner container 30 in a manner allowing the waste toner container 30 to slide. The second holding portion 511 may be provided at the support frame 5. The locking member 600 may be supported by the support frame 5 to slide between the locking position and the releasing position. The locking member 600 may be supported under the support frame 5 to slide in the sliding directions A1 and A2 of the print medium cassette 90. According to an example, the elastic member 700 may be implemented by a tension coil spring, one end of which is connected to the locking member 600 and the other end of which is connected to the support frame 5.

The locking member 600 may include a locking portion 610 to be caught by the opening lever 300 at the locking position to lock the opening lever 300, and a releasing portion 620 to interfere with the print medium cassette 90 and move to the releasing position when the print medium cassette 90 slides to the mounted position from the withdrawn position. The locking member 600 may slide in the pulling direction A1 to move to the locking position and slide in the mounting direction A2 to move to the releasing position.

Referring to FIG. 4, the locking portion 610 may be in the form of a protrusion protruding from the locking member 600 in the pulling direction A1. At the locking position, the locking portion 610 may interfere with the first holding portion 321. As marked with dashed lines in FIG. 4, when the locking member 600 is in the locking position, the locking portion 610 is located adjacent to the second position of the first holding portion 321 of the opening lever 300. In this state, the first holding portion 321 is blocked by the locking portion 610 and cannot move to the second position although the pressing portion 310 is pressed. Thus, the opening lever 300 is locked in the first position and the door 3 cannot be opened. When the locking member 600 is in the locking position, a first stopper 630 provided at the locking member 600 is brought into contact with a second stopper 520 provided at the support frame 5. Thus, the locking member 600 may be maintained at the locking position although the elastic force of the elastic member 700 is applied thereto.

As marked as the solid line in FIG. 4, when the locking member 600 is in the releasing position, the locking portion 610 is spaced apart from the first holding portion 321 in the mounting direction A2, and the opening lever 300 is in a state capable of moving to the second position. When the pressing portion 310 is pressed, the opening lever 300 moves to the second position, thereby releasing the first holding portion 321 from the second holding portion 511. The door 3 is in a state to be opened.

The print medium cassette 90 is located under the main body 1, i.e., under the support frame 5. The releasing portion 620 may be in the form of a protrusion extending from the locking member 600 downward toward the print medium cassette 90 to interfere with the print medium cassette 90 that slides to the mounted position from the withdrawn position. Referring to FIGS. 2, 5, and 6, the print medium cassette 90 includes an interfering portion 99 interfering with the releasing portion 620. When the print medium cassette 90 is in the withdrawn position, the interfering portion 99 is spaced apart from the releasing portion 620 and the locking member 600 is maintained at the locking position by the elastic force of the elastic member 700. When the print medium cassette 90 slides in the mounting direction A2 from the withdrawn position, the interfering portion 99 pushes the releasing portion 620 to move the locking member 600 in a direction opposite to the elastic force of the elastic member 700 to move to the releasing position.

Hereinafter, a process of replacing the waste toner container 30 will be described with reference to FIGS. 1 to 6.

Referring to FIG. 6, the print medium cassette 90 is in the mounted position and the door 3 is closed. The opening lever 300 is located in the first position. Because the first holding portion 321 is caught by the second holding portion 511, the door 3 is maintained in the closed state. Because the interfering portion 99 of the print medium cassette 90 is in contact with the releasing portion 620 of the locking member 600, the locking member 600 is maintained at the releasing position although the elastic force of the elastic member 700 is applied thereto. The locking portion 610 is spaced apart from the first holding portion 321 in the mounting direction A2. When the pressing portion 310 is pressed, the first holding portion 321 is released from the second holding portion 511 and the opening lever 300 moves to the second position. Thus, by opening the door 3 and sliding the waste toner container 30 in the pulling direction A1 as shown in FIG. 2, the waste toner container 30 may be removed from the main body 1. A new waste toner container 30 may be mounted in the main body 1 by sliding the new waste toner container 30 in the mounting direction A2. By closing the door 3, the first holding portion 321 is caught by the second holding portion 511 and the door 3 may be maintained in the closed state.

The print medium cassette 90 may move to the withdrawn position by sliding the print medium cassette 90 in the pulling direction A1 to load the print medium P in the print medium cassette 90. As the print medium cassette 90 slides in the pulling direction A1, the locking member 600 slides in the pulling direction A1 by the elastic force of the elastic member 700 to move to the locking position. As shown in FIG. 5, when the locking member 600 arrives at the locking position, the first stopper 630 is brought into contact with the second stopper 520 and the locking member 600 is maintained at the locking position. The locking portion 610 is located at a position adjacent to the second position of the first holding portion 321. In this state, the first holding portion 321 is blocked by the locking portion 610, and thus the first holding portion 321 cannot move to the second position although the pressing portion 310 is pressed. Thus, the opening lever 300 is locked in the first position and the door 3 cannot be opened.

After loading the print medium P in the print medium cassette 90, the print medium cassette 90 may slide and move in the mounting direction A2 to the mounted position. When the print medium cassette 90 slides in the mounting direction A2 to some extent, the interfering portion 99 of the print medium cassette 90 is brought into contact with the releasing portion 620 of the locking member 600. When the print medium cassette 90 continues sliding in the mounting direction A2 in this state, the locking member 600 is pushed by the print medium cassette 90 to slide in the direction opposite to the elastic force of the elastic member 700, i.e., in the mounting direction A2. The locking portion 610 is spaced apart from the first holding portion 321 in the mounting direction A2. When the print medium cassette 90 arrives at the mounted position as shown in FIG. 6, the locking member 600 arrives at the releasing position and the opening lever 300 is in a state capable of moving from the first position to the second position, and thus the waste toner container 30 may be replaced.

As described above, because the door 3 cannot be opened when the print medium cassette 90 is in the withdrawn position, the waste toner container 30 cannot be removed. Thus, an amount of contamination of the inside of the print medium cassette 90 caused by waste toner leaked during the process of replacing the waste toner container 30 may be reduced.

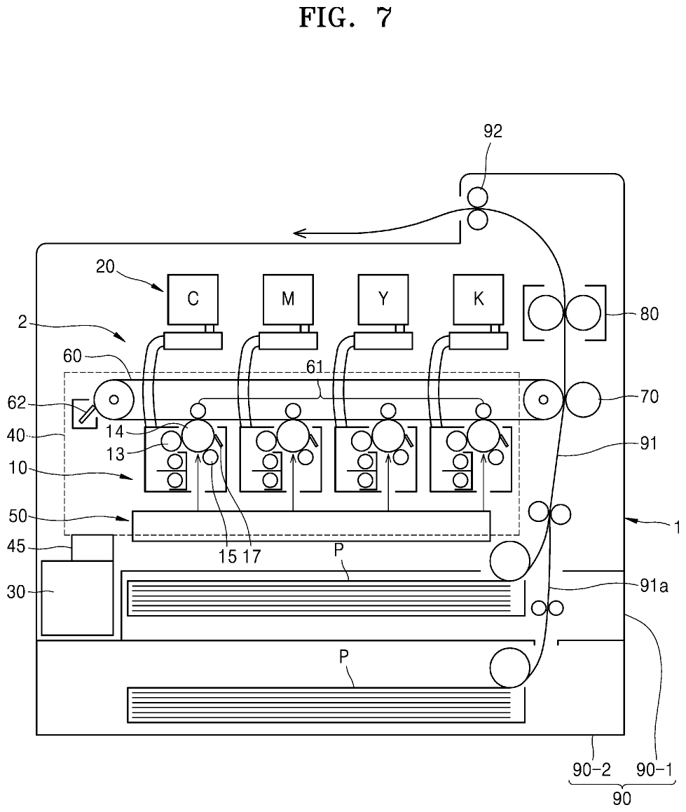

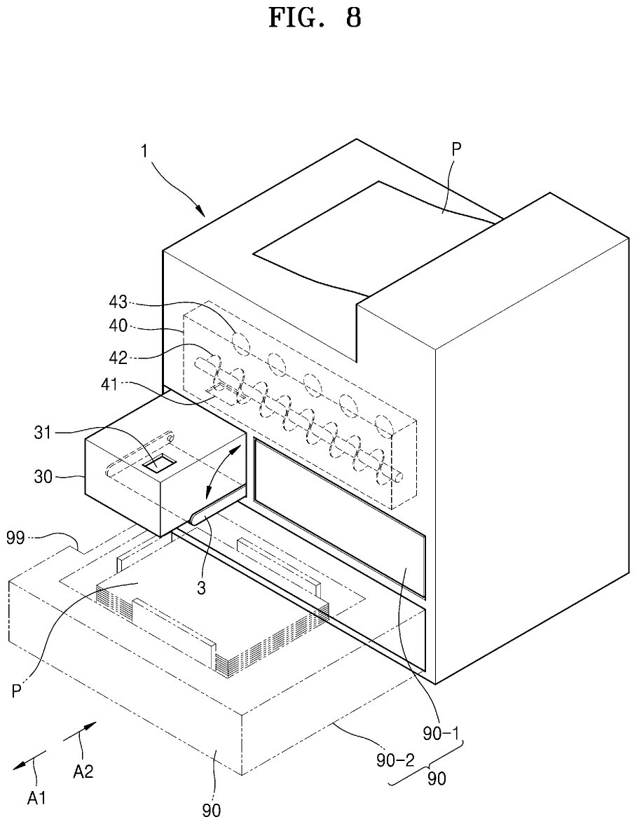

FIG. 7 is a view schematically illustrating an electrophotographic image forming apparatus according to an example. FIG. 8 is a perspective view illustrating an external appearance of the electrophotographic image forming apparatus shown in FIG. 7 according to an example.

The example of the image forming apparatus shown in FIGS. 7 and 8 is different from the image forming apparatus shown in FIGS. 1 and 2, in that the image forming apparatus shown in FIGS. 7 and 8 includes two print medium cassettes 90-1 and 90-2 and the opening of the door 3 is selectively allowed according to a position of the print medium cassette 90-2. Hereinafter, an example of the image forming apparatus shown in FIGS. 7 and 8 will be described based on differences from the example of the image forming apparatus shown in FIGS. 1 and 2. In the following description, the same or like elements are denoted by the same or like reference numerals, and a duplicate description will be omitted.

Referring to FIGS. 7 and 8, the image forming apparatus includes a main body 1 and a print medium cassette 90 that may be loaded with a print medium P to be fed into the main body 1. The print medium cassette 90 is movable between a mounted position in which the print medium cassette 90 is pushed into the main body 1 and a withdrawn position in which the print medium cassette 90 is pulled out from the main body 1. The main body 1 may include a printing unit 2, a waste toner container 30 to contain waste toner discharged from the printing unit 2, and a door 3 opened or closed for replacing the waste toner container 30. The printing unit 2 may print a color image on the print medium P by using an electrophotographic method. Because the printing unit 2 is the same as that described above with reference to FIG. 1, a duplicate description will be omitted.

The print medium cassette 90 may include a first print medium cassette 90-1 and a second print medium cassette 90-2. The first print medium cassette 90-1 is located under the main body 1. The second print medium cassette 90-2 is located under the first print medium cassette 90-1. The first print medium cassette 90-1 and the second print medium cassette 90-2 may independently slide both in the pulling direction A1 and the mounting direction A2 moving to the withdrawn position and the mounted position respectively to load the print medium P. The print medium P output from the second print medium cassette 90-2 is guided to the feed path 91 through a second feed path 91a. The second feed path 91a may be provided with at least one roller to transport the print medium P.

The waste toner produced from the printing unit 2 is stored in the waste toner container 30 as described above. As marked with dashed lines in FIGS. 7 and 8, an intermediate container 40 may be interposed between the printing unit 2 and the waste toner container 30. The intermediate container 40 may include a transport member 42 to transport waste toner to the waste toner container 30. A connection pipe 45 may be located between the intermediate container 40 and the waste toner container 30. Each of the waste toner outlet 41 and the waste toner inlet 31 may be connected to the connection pipe 45. The waste toner outlet 41 is connected to the waste toner inlet 31 via the connection pipe 45.

Referring to FIG. 8, the waste toner container 30 and the door 3 are located on a lateral side of the first print medium cassette 90-1. Thus, when the waste toner container 30 is replaced while the first print medium cassette 90-1 is open, the inside of the first print medium cassette 90-1 is less likely to be contaminated by waste toner. According to an example, the waste toner container 30 is located above the second print medium cassette 90-2. When the waste toner container 30 is removed from the main body 1 while the second print medium cassette 90-2 is in the withdrawn position, the inside of the second print medium cassette 90-2 and the print medium P loaded in the second print medium cassette 90-2 may be contaminated by waste toner falling from the waste toner container 30.

To address these problems, an image forming apparatus according to an example has a replacement structure for the waste toner container 30 which inhibits the door 3 from being opened when the second print medium cassette 90-2 is in the withdrawn position and allows the door 3 to be opened in conjunction with an operation of movement of the second print medium cassette 90-2 from the withdrawn position to the mounted position.

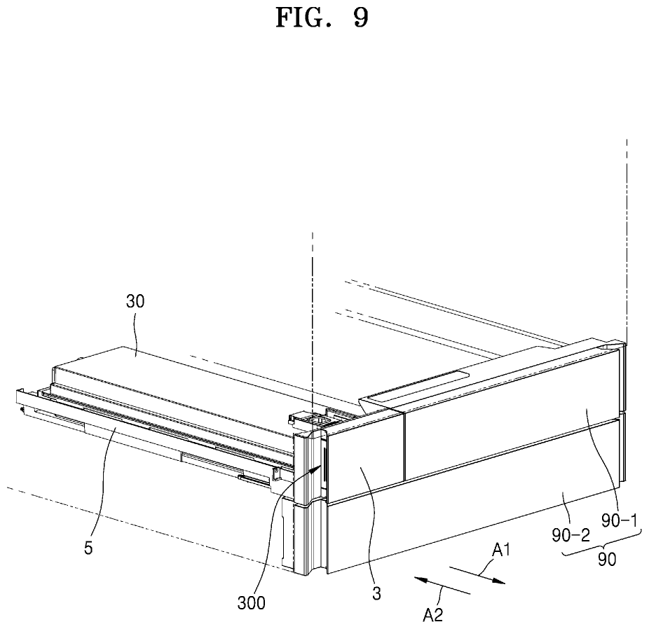

FIG. 9 is a schematic perspective view illustrating a replacement structure for a waste toner container applied to the image forming apparatus shown in FIG. 7 according to an example. The replacement structure for the waste toner container 30 illustrated in FIG. 9 may be identical to that illustrated in FIGS. 4 to 6. In this case, FIG. 4 is a bottom perspective view from which the second print medium cassette 90-2 of FIG. 9 is omitted. The print medium cassette 90 shown in FIGS. 5 and 6 may be considered the second print medium cassette 90-2 as marked in parenthesis.

The structures of the opening lever 300, the locking member 600, and the elastic member 700 are as defined above with reference to FIG. 4. However, the locking member 600 may move between a locking position, in which the opening lever 300 is locked in the first position, and a releasing position in which the locking of the opening lever 300 is released in conjunction with the movement of the second print medium cassette 90-2 from the withdrawn position to the mounted position. In addition, the second print medium cassette 90-2 includes an interfering portion 99 that pushes the locking member 600 to the release position from the locking position.

Hereinafter, a process of replacing the waste toner container 30 will be briefly described with reference to FIGS. 5 to 9.

Referring to FIG. 6, the second print medium cassette 90-2 is in the mounted position. Because the opening lever 300 is located in the first position and the first holding portion 321 is caught by the second holding portion 511, the door 3 is maintained in the closed state. Because the interfering portion 99 of the second print medium cassette 90-2 is in contact with the releasing portion 620 of the locking member 600, the locking member 600 is maintained at the releasing position although the elastic force of the elastic member 700 is applied thereto. By pressing the pressing portion 310, the first holding portion 321 is spaced apart from the second holding portion 511 and the opening lever 300 moves to the second position. By opening the door 3 and sliding the waste toner container 30 in the pulling direction A1 as shown in FIG. 8, the waste toner container 30 may be removed from the main body 1, a new waste toner container 30 may be mounted in the main body 1, and the door 3 may be closed.

When the second print medium cassette 90-2 slides in the pulling direction A1, the locking member 600 slides in the pulling direction A1 by the elastic force of the elastic member 700, thereby moving to the locking position. As shown in FIG. 5, when the locking member 600 arrives at the locking position, the locking portion 610 is located at a position adjacent to the second position of the first holding portion 321, thereby locking the opening lever 300 in the first position. Thus, the door 3 cannot be opened.

By sliding the second print medium cassette 90-2 in the mounting direction A2 to the mounted position, the interfering portion 99 of the second print medium cassette 90-2 is brought into contact with the releasing portion 620 of the locking member 600. In this state, when the second print medium cassette 90-2 keeps sliding in the mounting direction A2, the locking member 600 is pushed by the second print medium cassette 90-2, thereby sliding in a direction opposite to the elastic force of the elastic member 700, i.e., in the mounting direction A2. When the second print medium cassette 90-2 arrives at the mounted position as shown in FIG. 6, the locking member 600 arrives at the releasing position. The opening lever 300 is in a state capable of moving from the first position to the second position, and the waste toner container 30 may be replaced.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. An image forming apparatus comprising:
a main body comprising a printing unit, a waste toner container to contain waste toner, and a door;
an opening lever movable between a first position, in which the door is locked in a closed position, and a second position allowing opening of the door;
a print medium cassette located under the main body and movable between a mounted position and a withdrawn position; and
a locking member movable between a locking position, in which the opening lever is locked in the first position when the print medium cassette is in the withdrawn position, and a releasing position, in which the locking of the opening lever is released when the print medium cassette is in the mounted position.

2. The image forming apparatus of claim 1, further comprising an elastic member to apply an elastic force to the locking member in a direction toward the locking position.

3. The image forming apparatus of claim 2, further comprising a support frame located in the main body to support the waste toner container to allow the waste toner container to slide,
wherein the locking member is supported by the support frame to slide between the locking position and the releasing position.

4. The image forming apparatus of claim 3, wherein the print medium cassette comprises an interfering portion to push the locking member in a direction opposite to the elastic force of the elastic member, to move the locking member to the releasing position when the print medium cassette moves from the withdrawn position to the mounted position.

5. The image forming apparatus of claim 1, further comprising an intermediate container interposed between the waste toner container and the printing unit to contain waste toner discharged from the printing unit.

6. The image forming apparatus of claim 5, wherein the intermediate container includes a transporting member to transport waste toner to the waste toner container.

7. The image forming apparatus of claim 1,
wherein the print medium cassette comprises a first print medium cassette and a second print medium cassette located under the first print medium cassette,
wherein the waste toner container and the door are located on a lateral side of the first print medium cassette, and
wherein the locking member is moveable to the releasing position when the second print medium cassette is in the mounted position.

8. The image forming apparatus of claim 7, further comprising an elastic member to apply an elastic force to the locking member in a direction toward the locking position.

9. The image forming apparatus of claim 8, further comprising a support frame located in the main body to support the waste toner container to allow the waste toner container to slide,
wherein the locking member is supported by the support frame to slide between the locking position and the releasing position.

10. The image forming apparatus of claim 9,
wherein the opening lever comprises a first holding portion,
wherein the support frame comprises a second holding portion to catch the first holding portion in the first position, and
wherein the locking member comprises a locking portion to interfere with the first holding portion to prevent the opening lever from moving from the first position to the second position at the locking position.

11. The image forming apparatus of claim 9, wherein the second print medium cassette comprises an interfering portion to move the locking member to the releasing position by pushing the locking member in a direction opposite to the elastic force of the elastic member when moving from the withdrawn position to the mounted position.

12. An image forming apparatus comprising:
a main body comprising a printing unit, a waste toner container to contain waste toner, and a support frame supporting the waste toner container to allow the waste toner container to slide;
a first print medium cassette;
a second print medium cassette located under the first print medium cassette and movable between a mounted position and a withdrawn position;
a door located on a lateral side of the first print medium cassette;
an opening lever located at the door and movable between a first position, in which the door is locked in a closed position, and a second position allowing opening of the door; and
a locking member supported by the support frame to move between a locking position, in which the opening lever is locked in the first position, and a releasing position, in which the locking of the opening lever is released,
wherein the locking member is in the locking position, in which the opening lever is locked in the first position, when the second print medium cassette is in the withdrawn position, and is moveable from the locking position to the releasing position when the second print medium cassette is in the mounted position.

13. The image forming apparatus of claim 12, further comprising an elastic member to apply an elastic force to the locking member in a direction toward the locking position.

14. The image forming apparatus of claim 13, wherein the second print medium cassette is to push the locking member in a direction opposite to the elastic force of the elastic member to move the locking member to the releasing position when the second print medium cassette moves from the withdrawn position to the mounted position.

15. The image forming apparatus of claim 14, further comprising:
an intermediate container interposed between the waste toner container and the printing unit to contain waste toner discharged from the printing unit; and
a transporting member located in the intermediate container to transport waste toner to the waste toner container.
